(19) United States
(12) Patent Application Publication
(10) Pub. No.: US 2012/0130737 A1
(43) Pub. Date: May 24, 2012

(54) SYSTEM AND METHOD FOR DISTRUBUTOR REPORTING AND ANALYSIS

(75) Inventors: Robert Finizio, Boca Raton, FL (US); Brian Bernick, Boca Raton, FL (US); John Milligan, Ocean Ridge, FL (US)

(73) Assignee: THERAPEUTICSMD, INC., Boca Raton, FL (US)

(21) Appl. No.: 13/361,678

(22) Filed: Jan. 30, 2012

Related U.S. Application Data
(63) Continuation-in-part of application No. 12/561,515, filed on Sep. 17, 2009.

(51) Int. Cl. G06Q 50/22; G06Q 30/02

(52) U.S. Cl. 705/2; 705/7.32

(57) ABSTRACT

In various embodiments, a research and development system that gathers feedback from patients and healthcare providers with respect to the their experience with various aspects of a supplier's products in order to tabulate, consolidate, compare and analyze the data received rapidly and efficiently, and which can be used on successive iterations to determine future products and services.

### CROSS-REFERENCE TO RELATED APPLICATIONS

This application is a continuation-in-part of U.S. Ser. No. 12/561,515, entitled “System and Method of Ongoing Evaluation reporting and Analysis,” flied on Sep. 17, 2009, the entire disclosure of which is incorporated herein by reference.

### FIELD

The present disclosure relates to systems and methods for capturing and analyzing feedback about products, and more specifically, for comparing performance against feedback from various groups.

### BACKGROUND

Much of the research and development in the healthcare industry is currently done on an infrequent basis with limited customer feedback, Surveys are periodically sent out to a limited pool of customers with marginal quality feedback, relative to collection rates. This leads to lower quality products and substantial lag time in reacting to customers ever changing needs, Most companies doing traditional, episodic, and limited customer surveys take years to release new products and enhance existing products and services. This type of traditional market research and development results in: (1) limited success in discovering any gaps in the product portfolio, (2) considerable lag time in discovering product inconsistencies and quality issues, (3) prolonged development cycles, (4) poor customer satisfaction and retention, and (5) increased development cost, and therefore, increased cost to the customer.

Known solutions in the art include paper based periodic customer surveys, periodic telephone surveys, door to door/in-person surveys and periodic internet Spam surveys.

### SUMMARY

In various embodiments, customers who have purchased items from a supplier whose information and email addresses are stored in the system and a dealer of the items are extended invitations to complete linked surveys. Customers and dealers may report requested information via the system. Forms with questions and free text field to enter data collected are provided. Once the forms are completed, they are sent via a network and analyzed. This information is used to enhance current items and/or create new items.

In various embodiments, the disclosure provide systems, methods and computer readable medium configured to perform operations with a computer based system for analyzing survey data. The computer based system is configured to operations comprising receiving response data from a plurality of completed survey, parsing the response data into a plurality of subsets based on at least one of a survey type, a product identifier, and a user identifier, and analyzing at least one of the subsets, and creating a representation of the data. In these embodiments, the representation may be indicative of use of an item. The response data may comprise objective response data. This objective response data may be a response to a survey question associated with predefined answers. The response data may also comprise subjective response data. The subjective response data may be response to a survey question that is not associated with predefined answers.

In various embodiments, the item may be a service or product. The product may include at least one of a prescription medication, a prescription medical supplement, and a non-prescription supplement.

In various embodiments, the computer based system may be configured to perform additional operations, comprising sorting the subjective data based on a key word and identifying the subjective data comprising the key word, The computer based system may further be configured to group the subjective data comprising the key word, and create a report, wherein the key word is modified in the report. The key word may be, for example, an attribute of a product that is a predefined key characteristic of the product.

In various embodiments, the computer based system may be further configured to validate a user based on login information, and display a plurality of options in response to the login information matching criteria associated with a user. The plurality of options may comprise at least one of a report option, a task list option, and a survey completion history option, and/or the like. The computer based system may receive a selection associated with the report option, receive an item selection in response to receiving the selection of the report option, and display an indicator of the user's use of an item and the total use of an item.

In various embodiments, the computer based system may be further configured to perform operations comprising, tracking an activity of a customer, and displaying the status of the activity, such that the status is associated with the customer, In these embodiments, the activity may be associated with a re-occurring order for the item.

In various embodiments, the computer based system may be further configured to receive a selection associated with the task list, display a task in response to receiving the selection of the report option, and receive first data and second data, The task may be displayed based on an item associated with the user. The first data may be a selection of predefined answer associated with a first survey question, and the second data may be information provided by a user associated with an observation about the item from the user. Moreover, the second data may be provided in a field, and the field may be associated with a particular set of predetermined key characteristics that suggest how the observation from the user should be described.

The systems and methods described herein utilize the computer networks and gather feedback from customers and dealers with respect to the their experience with various aspects of a company's items in order to tabulate, consolidate, compare and analyze the data received which is used to determine future items.

The process starts with the dealers receiving feedback from their customers relative to their experience with subject items. Dealers may be asked to gather a combination of objective and subjective customer experience data. The dealers enter this data into a form that may be accessed via the Internet. The dealers also enter their own impressions and opinions relative to the subject products and services.

After the data has been fully analyzed, the information available from the system is used to determine characteristics of a future product pipeline, including enhancements to current products as well developing new product additions to the portfolio.

The reporting mechanism of the system results in measurements that help to understand the quality and capability of a product, including an index of qualities against a Six Sigma yardstick. Accordingly, these systems and methods help assure the development and changes to products and additional product lines based on verifiable data, rather than assumptions. As these changes come to market, the system's cycle of continuous customer and dealer feedback and resultant improvement continues.

The systems and methods produce quantifiable customer and dealer feedback that can be immediately implemented resulting in sustained quality improvement. Furthermore, the systems and methods accelerate improvement in all aspects of the business process from product development to customer service by improving quality and reducing waste and defects.

The systems and methods gather demographics from every customer and the associated dealer that buys a product from the system. The systems and methods also create survey questions for customers and dealers that can be customized to a specific item. The systems and methods may also identify potential survey takers by captured demographic information and extend surveys to only those whose demographics/experience would be most wanted with respect to a product or service.

In various embodiments, the systems and methods tabulate and analyze the data with respect to demographics of its participants and survey responses for the company hosting and administering the system and can also be made available to any secondary client interested in aggregating specific survey response statistics through the defined pool of customers/customers and dealers of the hosting company that will serve as surveyors.

In various embodiments, the systems and methods may provide a compensation mechanism for which a benefit can be provided to the surveyors to support product distribution and feedback compliance.

Accordingly, in various embodiments, the systems and methods solve the lack of adverse reporting with respect to items such as, for example, nutritional supplements, medications, or any other suitable item. These systems and methods provide all the necessary information to evaluate an event including consumer, product, and manufacturer information as well as data needed to analyze any trends.

In various embodiments, a reporting, engine may configured to provide specific measurements that help with understanding the qualities and capabilities of an item, and may index those qualities against a Six Sigma yardstick.

In various embodiments, the system may gather, tabulate, consolidate, compare and analyze the data received from multiple physicians. Once the data is analyzed, the information will be used to determine the characteristics of future items created with the benefit of the information obtained by the system, including enhancements to current items and development of new items for a supplier's portfolio. In various embodiments, this helps assure that development and changes to current items and additional items are based on verifiable data, rather than assumptions. As such, the systems and methods capture continuous customer and dealer feedback, which insures constant product improvement.

Furthermore, the data-driven approach of the systems and methods described herein allow for an accurate understanding of the customer's (customers and dealers) transaction lifecycle. With this data, areas where significant value or improvement can be identified. For example, the data may be used to provide accelerated item improvement in all aspects from price to item development to customer service by improving quality and reducing waste and defects.

In various embodiments, the systems and methods create a more efficient, statistically superior, item research and development system that efficiently and continuously collects high quality analytical and subjective customer data. Moreover, the continuous monitoring aspect of the system drastically reduces cycle time and improves productivity, while reducing cost. Other features may include real time monitoring and development feedback loop between dealer, customer and company erasing traditional item development gaps, elimination of current item issues and inconsistencies through constant monitoring, and elimination of lag from traditional new item to market research periods.

Other aspects of various embodiments include provisions for quality feedback from critical dealer constituency, continuous monitoring of customer and item success rates, provision of customer level data, consideration of analytical and subjective data to capture full customer experience, provision of the ability for a item supplier to personalize items quickly, reduction of overall cycle time for item development, provision of quick reaction time to item problems/issues, and provision of a broader customer base.

### BRIEF DESCRIPTION OF THE DRAWINGS

A more complete understanding of the present disclosure may be derived by referring to the detailed description and claims when considered in connection with the Figures, wherein like reference numbers refer to similar elements throughout the Figures, and:

FIG. 1 is a block diagram for the obtaining and analyzing feedback from dealers and customers in accordance with various embodiments;

FIG. 2A is a flow process for the obtaining and analysis of feedback from dealers and customers in accordance with various embodiments;

FIG. 2B is a block diagram for the obtaining and analysis of feedback from dealers and customers in accordance with various embodiments;

FIG. 2C is a diagram of a portal available to dealers comprising customer information in accordance with various embodiments;

FIG. 2D is a diagram of a comparative analysis available to dealers in accordance with various embodiments;

FIG. 3 is a flow process of the supplier's survey development portion of the system in accordance with various embodiments;

FIG. 4 is a flow process of the survey selection and data acquisition portions of the system in accordance with various embodiments;

FIG. 5 is a flow process of the customer-dealer link portion of the system in accordance with various embodiments;

FIGS. 6A, 6B, and 6C urea sample survey generated by the system in accordance with various embodiments; and

FIGS. 7A and 7B are a sample survey generated by the system in accordance with various embodiments.

### DETAILED DESCRIPTION

The detailed description of exemplary embodiments herein makes reference to the accompanying drawings and pictures, which show the exemplary embodiment by way of illustration. While these exemplary embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

The present disclosure produces a quicker, more accurate, statistically superior, analytically and subjective based research product development system.

The present disclosure is a more efficient, statistically superior, product research and development system that efficiently and continuously collects high quality analytical and subjective customer data. Moreover, the continuous monitoring aspect of the system (enabled through a computer communication system) improves productivity, while reducing cost. Aspects of the systems disclosed herein are superior, faster and cheaper than other research and development systems.

Additionally, this system is suitable for dietary supplements because the Food and Drug Administration does not require dietary supplements to undergo pre-market approval for safety and efficacy. Instead, the FDA relies mostly on its adverse event reporting system to identify safety problems. However, because reporting is entirely voluntary, adverse event reporting systems typically detect only a small proportion of the events that occur. One FDA-commissioned study estimated that less than 1 percent of all adverse events associated with dietary supplements are actually reported.

Phrases and terms similar to an “item” may include any good, service, information, experience, data, content, access, rental, lease, anything of value, something of minimal or no value, monetary value, non-monetary value and/or the like.

As used herein, a “customer” may include any consumer of items. In the context of a medical application using the systems and methods described herein, “customer” includes, for example, any consumer of medication (e.g., over the counter medication, and/or prescription medication), supplements (e.g., over the counter supplements, and/or prescription supplements) and healthcare services, a patient, an affiliate of a patient, an agent of a patient, regardless of whether a customer doctor relationship attaches. In the context of an automobile application using the systems and methods and described herein, “customer” includes, for example, a purchaser, an owner, an operator, and/or the like.

As used herein, a “dealer” may include any person or entity that sells, prescribes, distributes, and/or recommends an item. Further, in the context of a medical application using the systems and methods described herein, a “dealer” includes “a health care provider” (e.g., nurse, physician's assistant, a nurse practitioner, and/or the like), “doctor,” and/or “physician” are defined herein to also mean other providers of healthcare services, regardless of whether a patient-doctor relationship attaches. In the context of an automobile application using the systems and methods and described herein, “dealer” includes, for example, merchant (e.g., a car dealership), a reseller, a manufacturer, a component provider, and/or the like.

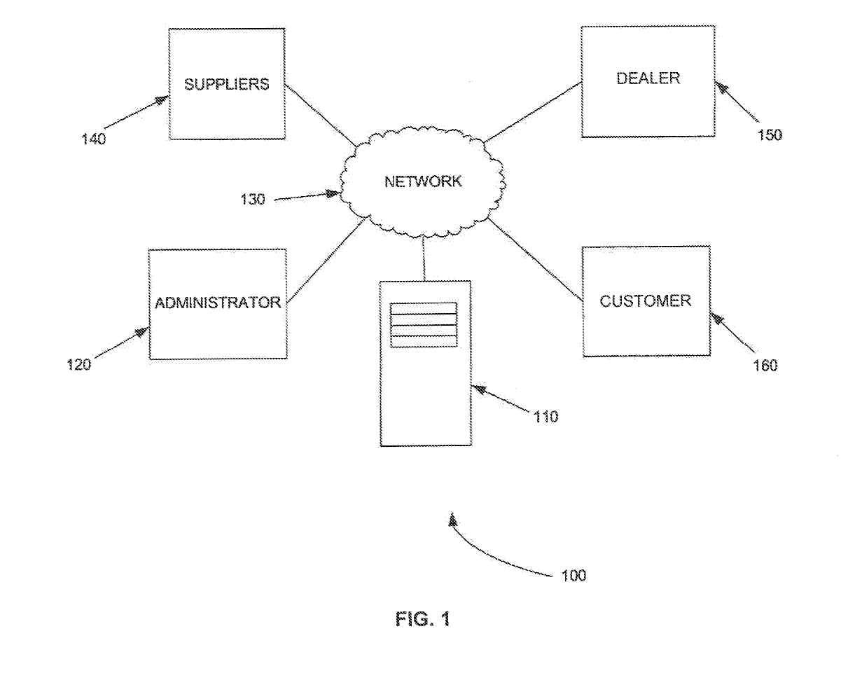

In various embodiments, and with reference to FIG. 1, system 100 may be configured obtain and analyze feedback from dealers and customers. System 100 can include a host server 110 configured for communicative coupling with an administrator 120 over a computer communications network 130 to different computing devices for different users of the system. Administrator 120 may be coupled to the host server directly or over computer communications network 130. Similarly, the other users such as, for example, suppliers 140, dealers 150 and customers 160 may be coupled to host server 110 directly or over computer communications network 130. Host server 110 may support the operation of the system 100; however, other means for supporting the operation of a system over a computer communications network are known in the art.

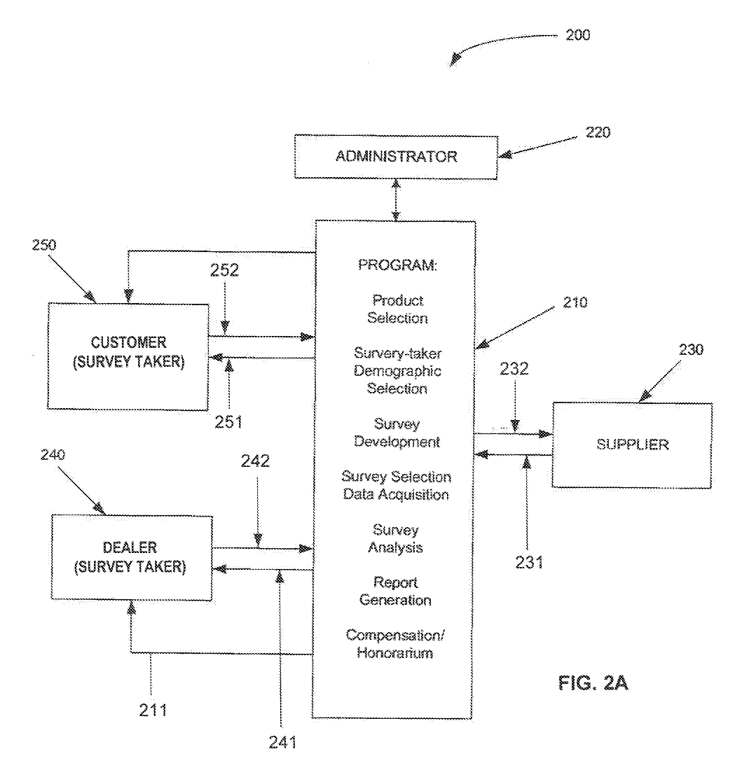

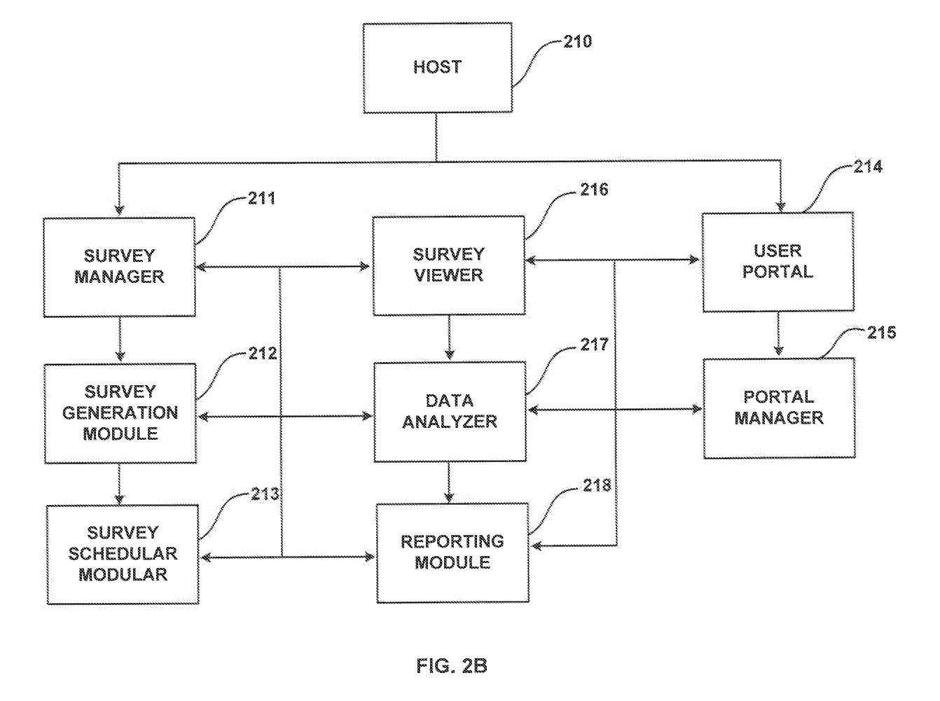

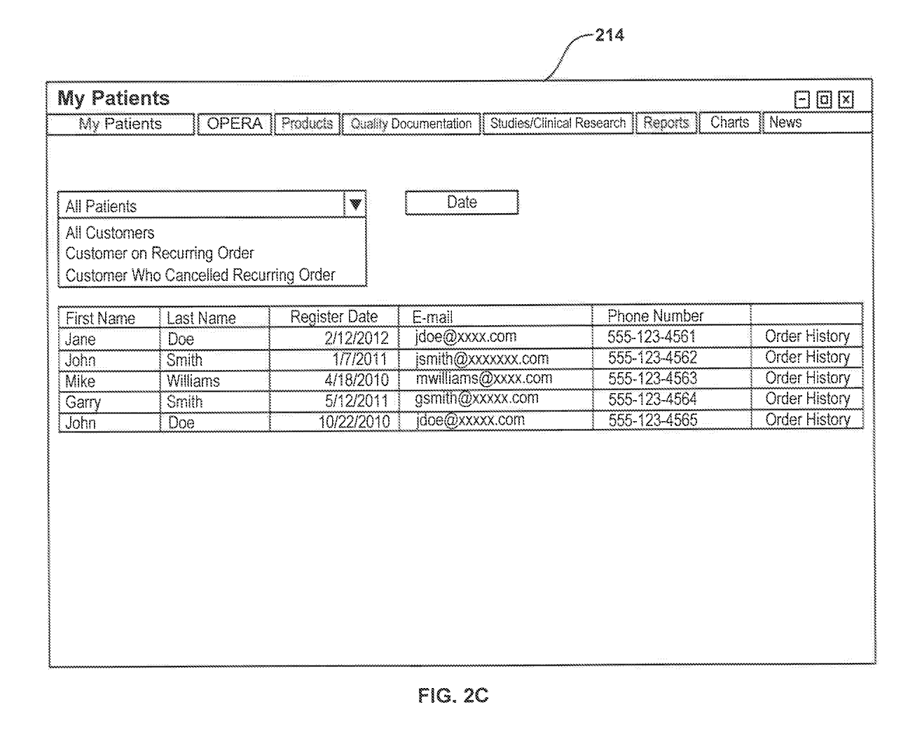

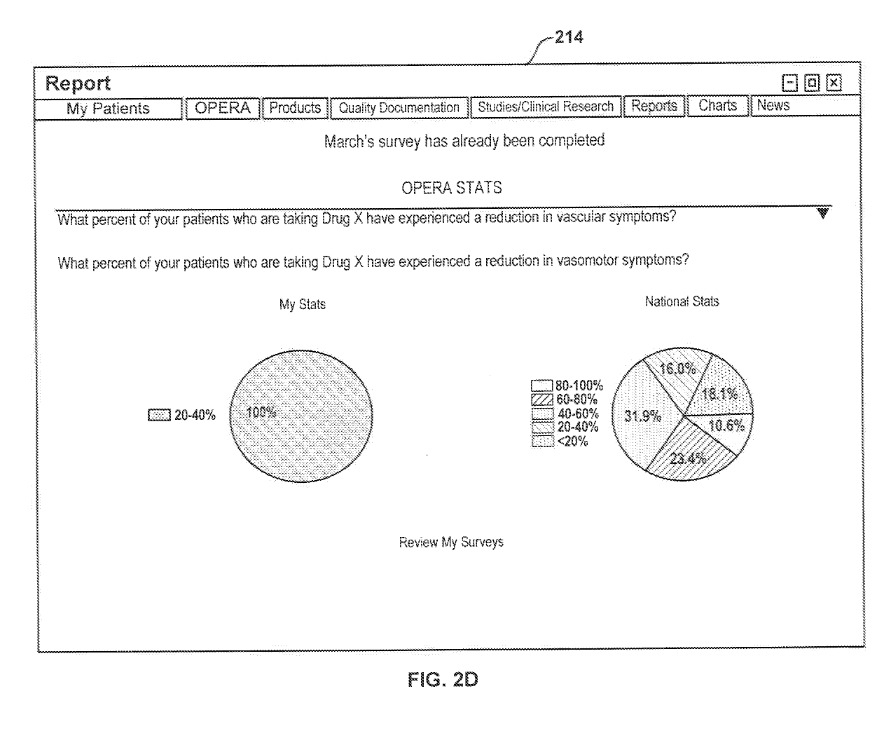

In various embodiments, and with reference to FIG. 2A, system 200 comprises host 210. Host 210 provides interaction between administrator 220, supplier 230, dealer 240 and customer 250. As shown, host 210 includes several steps, including product selection, demographic selection, survey development, survey selection and data acquisition, survey analysis, report generation and a benefit (e,g., compensation, an honorarium, a discount, a coupon, and/or the like). Supplier 230 provides survey parameters 231 for host 210 and host 210 then uses that data to create a survey form 232 for selection and editing, if needed, by supplier 230. The survey form is then provided to dealer 240 or customer 250, or both by electronic communication 211 including, for example, such as email or access to a web page on a computer communications network. The response 242 from dealer 240 and response 252 from customer 250 to the survey may be captured and stored by host 210 from dealer 240 or customer 250, or both. A benefit, confirmation, or other suitable feedback 241 and a benefit, confirmation, or other suitable feedback 251 may be provided to dealer 240 or customer 250, respectively, or both, for participation in one or more surveys.

In addition, the responses provide information which can lead to improvements in the product supplied to supplier 230, and a new survey may be taken regarding the new product. Several iterations may occur, where a survey is used throne or more features of the product, resulting in a more improved product, or one or more products with more advantageous features.

in various embodiments with reference to FIG. 2B, host 210 may comprise a survey manager 211, a survey generation module 212, and a survey scheduler module 213. Host 210 may comprise a user portal 214 and a portal manager 215. Host 210 may also comprise a survey viewer 216, a data analyzer 217, and a reporting module 218. In these embodiments, each of the components in configured to communicate with every other component.

Survey manager 211 may any suitable hardware, software, or hardware-software component or system configured to manage surveys. Survey manager 211 may track, store, manipulate, or otherwise manage one or more surveys. In various embodiments, survey manager 211 provides an administrator and/or user with access to survey generation module 212, survey scheduler module 213, and various other module, engine, viewers, and/or the like through a user interface. Based on the inputs received from the administrator/user, the survey manager may load one or more components.

Survey generation module 212 is any suitable hardware, software, or hardware-software component or system configured to generate surveys in response to inputs received survey manager 211 (or instruction provided by survey manager 211). Survey generation module 212 may be configured to create one or more fields. These fields may comprise drop down menus and/or boxes that comprise predefined questions, instructions, and/or statements. The questions, instructions, and/or statements may he directed to or associated with a general item (e.g., demographic information) or a specific item (e.g., a specific product). The predefined questions may be associated with predetermined answers. The predefined questions may also be associated with a field or text box, where a user is able to provide specific information or observations regarding the question.

The predefined questions may be design to collect required data or data that is desirable to a product manufacturer. In an embodiment with a survey directed to prescription drugs, the question may be designed to collect adverse event data or side effect data. These questions and the associated responses may be required for regulatory and/or reporting purposes. In other embodiments, with a survey directed to automobiles, the questions may be designed to collect operational data, performance data, and/or the like.

The instructions and/or statements may include suggestions about how a particular question should be answered. For example, the instructions and/or statements may include one or more key words that are suggested for a response so that the response can be identified during processing. In an embodiment with a survey directed to a vitamin supplement, the statement or instruction may suggest including the word “taste” or “smell” for a question about the how easy the supplement is to take. The system then identifies and collects all responses to the question that contain the key word and group them so that the specific comments can be evaluated. The comments may be used as input to drive a product change, refinement or new product.

Survey generation module 212 may also be configured with a custom question generator. The custom question may include a field that allows us user to enter or create a custom question that is otherwise not available as a predefined question. The custom question generator may be associated with one or more answer options, including for example multiple choices, ranked answers (e.g., very important, somewhat important, not important, predetermined answer option (e.g., yes or no), or a field that allows a user responding to the survey to provide their own answer (e,g., a text field). The custom question generator may also comprise a statement and/or instruction field, which allows the creator of the question to provide specific statements or instruction about how the custom question should be answered.

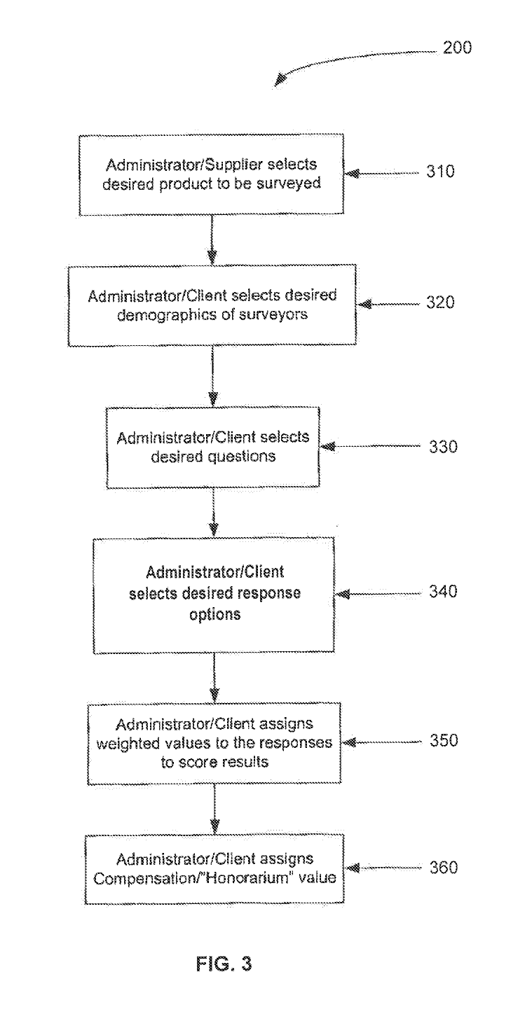

With momentary reference to FIG. 3, during creation of a survey the administrator or supplier may select the product to be the subject of a survey (Step 310). The administrator may select the desired demographics of the customers and/or dealers who will be responding to the surveys (Step 320). The administrator may also include desired questions for the survey (Step 330). if appropriate, the administrator assigns the desired response options for the survey taker (Step 340). The administrator may also assign weighted values to the responses for scoring of the results of the surveys (Step 350). In addition, the administrator may assign a benefit for the dealer or the customer, or both (Step 360).

Survey scheduler module 213 is any suitable hardware, software, or hardware-software component or system configured to schedule, track, monitor and distribute surveys. Survey scheduler module 213 may comprise or be associated with a communication module. The communication module may comprise any form of suitable electronic communication including, for example, an database containing e-mail addresses associated with customers and/or dealers, phone numbers associated with customers and/or dealers, or any other suitable contact information. The communication module may also be configured to create an electronic communication for a survey. The electronic communication may be an e-mail, a link that is distributed to customers and/or dealers, or any other form of suitable electronic communication.

Survey scheduler module 213 may also be configured to distribute surveys for completion at predetermined times (e.g., survey start date). This predetermined time may be established by a survey creator or administrator. Survey scheduler module 213 may also send a survey out in response to any suitable triggering event. For example, survey scheduler module 213 may receive product sales information from one or more systems, and in response to the product sales information being above a predetermined threshold, survey scheduler module 213 may automatically deliver a survey. Survey scheduler module 213 may also send a survey at predetermined intervals (e.g., monthly), in response to product sales information being below a predetermined threshold, or in response to any other suitable triggering event. Additionally, survey scheduler module 213 may assign a tracking ID to each survey to confirm that the right person is responding to the right survey. Survey scheduler module 213 may also be configured to track the completed and outstanding surveys, send reminders about outstanding survey to be completed, and any other suitable tracking and/or monitoring activities. After a predetermined time, the reminders may stop, and access to the website having the survey may be denied.

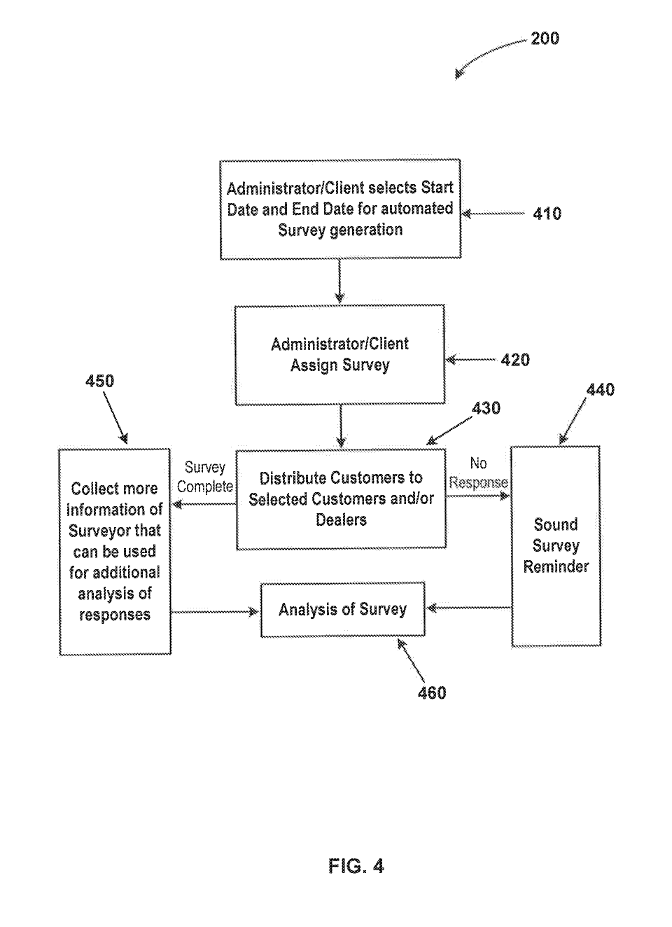

With momentary reference to figure FIG. 4, in operation the administrator may select a start date and an end date for the survey (Step 410) and assign surveys to be sent to one or more dealers, customers or both (Step 420). The survey may then be sent to each of the identified customers and/or dealers, in response to a trigger event (e.g., a predetermined time, a sales volume, and/or the like). System 200 may be configured to send reminders or resend the survey to a particular customers and/or dealer at predetermined times, in response to a particular customer and/or dealer not completing the survey (Step 440). For example, reminders may be sent alter 2 and 4 weeks. If the survey is answered to a predetermined amount of completion, then additional information may be obtained from the dealer (Step 450). This additional information may include demographic information or other general information and may be used to aid in the analysis of the responses to the survey (Step 460).

In various embodiments, user portal 214 is any suitable hardware, software, or hardware-software component or system configured to provide access to surveys and/or survey results. User portal 214 may be configured to grant customers and dealers access to surveys. User portal 214 may be configured with a login screen. A user may provide a login information (e.g., a username and password), that are captured by user portal 214 and compared to user account criteria. Where the user account criteria matches the login information, the customer or dealer may he provided access to user portal 214. Based on the login, the user portal may be configured to enable and/or display features associated with the user. For example, if a customer provides log in information and gains access to the portal, user portal 214 is configured to enable and/or display modules and/or features that are specific to the customer (e.g., an outstanding survey for a product purchased and/or used by the patient).

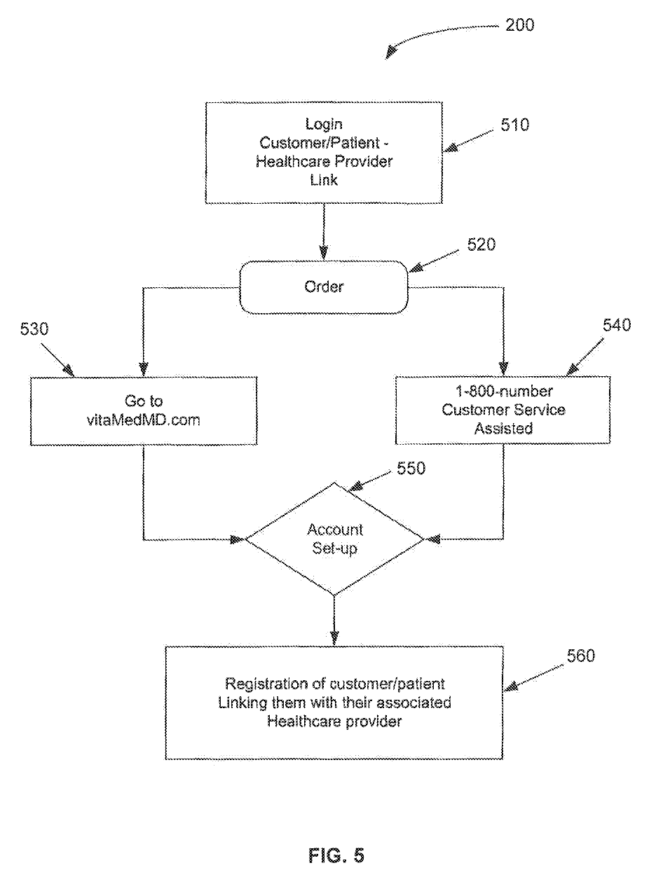

In various embodiments and with momentary reference to FIG. 5, in operation the login process for the customer connects the customer with the dealer at the time the customer purchases an item (Step 510). An order is made for a particular item by the customer or the dealer (Step 520). The order may be made by either visiting the administrator's or supplier's website (Step 530) or by dialing a customer service number (Step 540) or by equivalent means. The customer is identified and correlated with the customer's dealer whose identity has already been entered in the system. Once the customer has been identified as being associated with the dealer, the customer account is set up (Step 550), and the customer is registered with the program, the customer is linked with the associated dealer (Step 560).

In various embodiments, system 200 may be configured to interface with an electronic medical records system (an “EMR”). The EMR may be configured to provide data to system 200. Based on the data provided by the EMR, a profile may be established from the customer. In various embodiments, the EMR may comprise, provide or associate an identifier with data provided. This identifier may associate the customer data and/or profiles with a particular dealer. Based on this association, the dealer may receive data about the consumer from system 200.

In various embodiments and with reference to FIG. 2C, a dealer provides log in information and gains access to the portal, user portal 214 is configured to enable and/or display modules and/or features that are specific to the dealer. In a medical application, user portal 214 may be configured with a patient tab that lists all of the patients (e.g., customers) associated with a healthcare provider (e.g., dealer). The patient tab may be configured with one or more filters that allow the health care provider to sort or filter the associated patients. For example, the filter may allow a health care provider to determine the order status of various patients. Often patient may have re-occurring or auto-fill orders for a prescription, nutritional supplements, therapies, and/or the like. The filter may be configured to allow the healthcare provider to sort or filter patients listed with at least one associated re-occurring or auto-fill order. The filter may also be configured to allow the healthcare provider to sort or filter patients listed, who have cancelled at least one associated re-occurring or auto-fill order. This may indicate to the doctor that a particular therapy is not effective for the patient who cancelled the order, is too expensive for the patient who cancelled the order, or has caused an issue for the patient who cancelled the order. This feature may also allow the doctor to make a note to discuss the particular circumstances that lead to a cancellation to better serve the patient.

Referring again to FIG. 2B, Portal Manager 215 is any suitable hardware, software, or hardware-software component or system configured to the features and tasks associated with a user. Portal manager 215 may comprise a task list, a history of tasks completed, and any other suitable portal management metrics. Portal manager 215 may be configured with a notification system that is configured to send a message when a survey is available for completion. Portal Manager 215 may also be configured to provide notifications when a survey available for completion is approaching or past a predetermined due date for completion.

In various embodiments, survey viewer 216 is any suitable hardware, software, or hardware-software component or system configured to communicate and/or display surveys. Survey viewer 216 may be in communication with, associated with, or accessible through survey manager 211, user portal 214 and/or any other suitable module or engine of the system. Survey viewer 216 may display a survey, created by survey generation module 212, to a customer and/or dealer. Survey viewer 216 may be configured to present one or more questions, associated instruction and/or statements, and answer fields at a time. Survey viewer 216 may also be configured to capture and record or transmit customer or dealer answers to each question.

Data analyzer 217 is any suitable hardware, software, or hardware-software component or system configured to receive, analyze, manipulate, process and/or modify data. Data analyzer 217 may be in communication with, associated with, or accessible through survey viewer 216 or any other suitable component of the system. Data analyzer 217 may also be in configured to receive data indicative of a customer or dealer response to a survey question from survey viewer 216.

In various embodiments, data analyzer 217 is configured to analyze the data from survey viewer 216 in any suitable fashion. For example, data analyzer 217 may be configured to compile data from various users for a particular survey and then analyze the data to determine results that are indicative of a market for an item. The market may be associated with a demographic (e.g., purchase activity associated with an item for a particular segment of a population) and/or geographic information (e.g., purchase activity associated with an item in a particular region). Data analyzer 217 may also analyze the data from a single survey response or a particular answer in a survey. In this way, data analyzer 217 can identify an answer to a survey question that deals with a particular item feature and/or issue. Data analyzer 217 may comprise or be configured with any suitable algorithm, search, parsing, or other suitable data analysis tool and/or feature.

Reporting module 218 is any suitable hardware, software, or hardware-software component or system configured to receive, display, render, manipulate, and/or modify data. Reporting module 218 may be in communication with, associated with, or accessible through data analyzer 217 or any other suitable module and/or component of the system. Reporting module 218 may be configured to render data analyzed by data analyzer 217 in any suitable fashion including, for example, in a graphical format, in a table format, or in any other suitable format.

In various embodiments, reporting module 218 may be configured to provide a report comprising graphical comparative data. This data may allow a dealer to compare the dealer's performance to the performance of a larger population. For example, in an embodiment, where the system is associated with automobile sales, the reporting module 218 may be configured to display sales data (e.g., in a graphical format) that is indicative of sales of all automobiles, sales of a particular product, sales of an identified feature, and/or the like for a particular dealer. Reporting module 218 may also display similar sales data for a larger population of dealers (e.g., ail dealers, dealers of particular products, dealers in a particular region, a feature of an item, and/or any other suitable parameter). This report allows a dealer to evaluate the sales performance of the individual dealer against other dealers. It may also help the dealer identify sales trends that cause the dealer to change its approach to selling automobiles or particular available features.

In various embodiments, and with momentary reference to FIG. 2D, in operation in a medical application, reporting module 218 may be configured to generate a report comprising information associated with all patients, a class of patients, a particular patient, all items, a class of items, a particular item, all healthcare providers, and/or a particular class of health care providers. For example, a healthcare provider may select a particular item (e.g., “Drug X,” which may be any therapy, nutritional supplement, vitamin, and/or the like). Based on this selection, reporting module 218 may display a first graphical data indicative of a healthcare provider's activities with a particular item and second graphical data indicative of a group of healthcare providers' activities with the item. This comparative graphical representation allows the healthcare provider to quickly asses her own performance against the performance of a larger group of healthcare providers. As noted above, this comparative representation may also help the healthcare provider evaluate her activities with respect to the particular item.

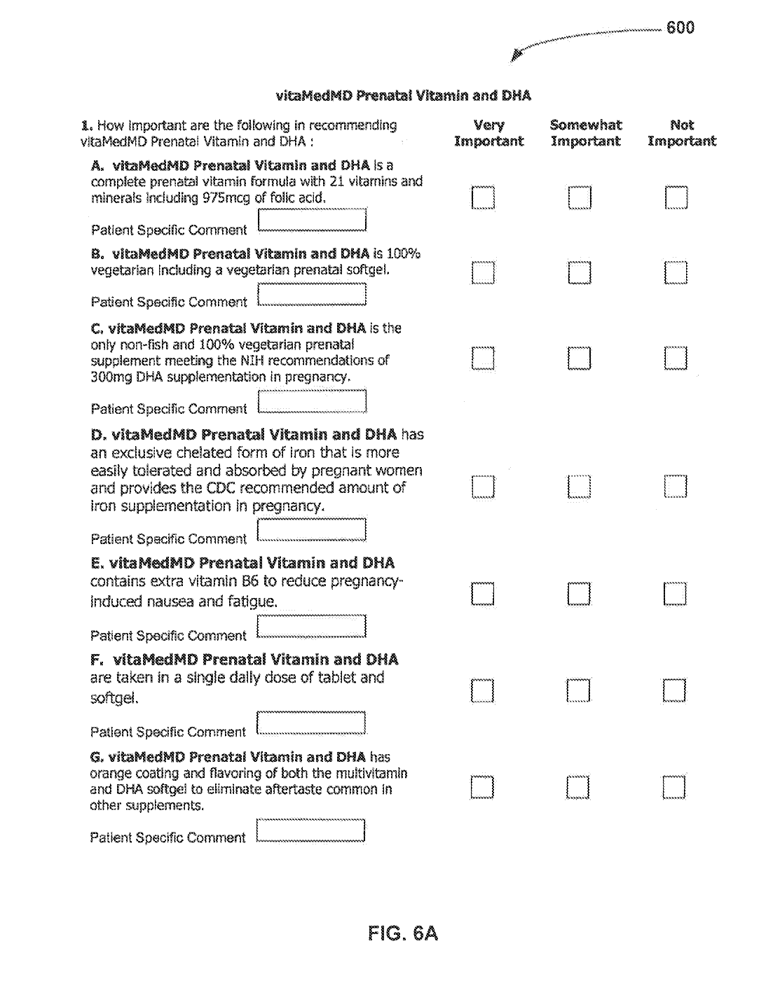

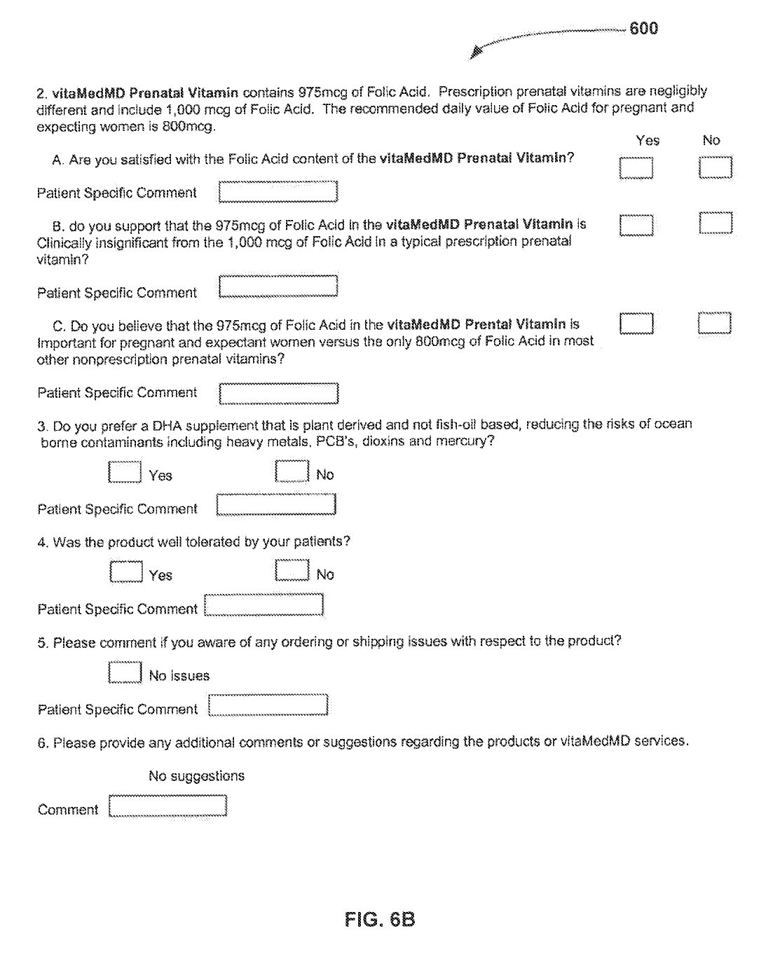

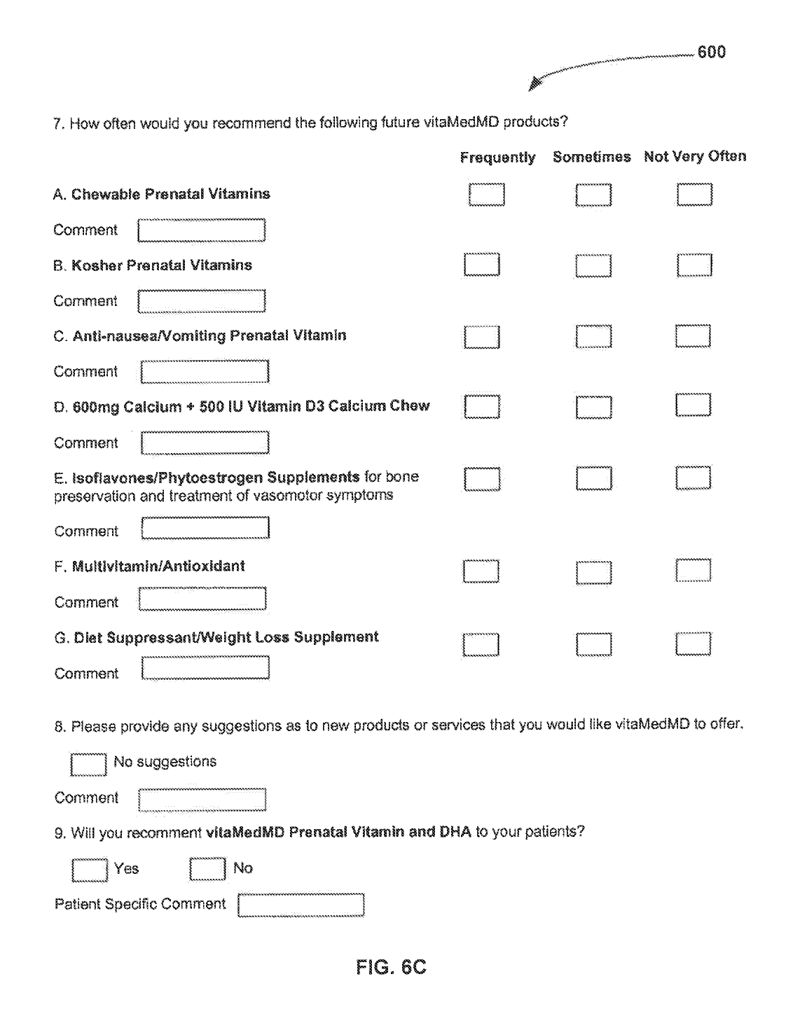

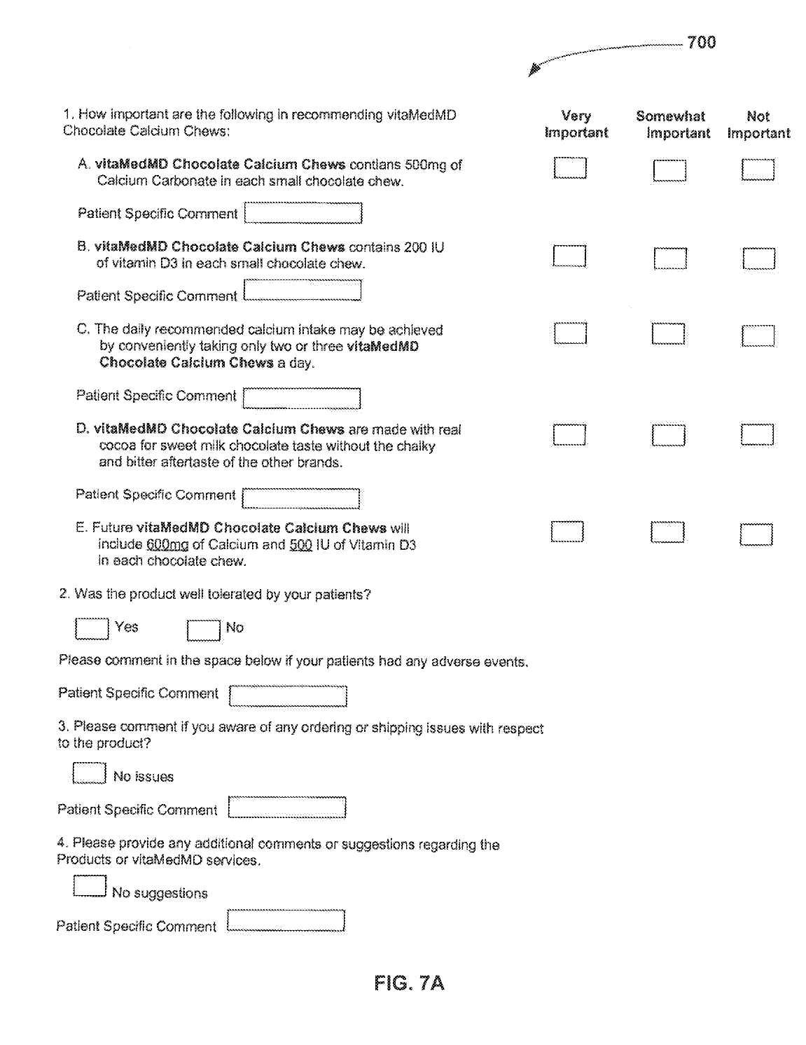

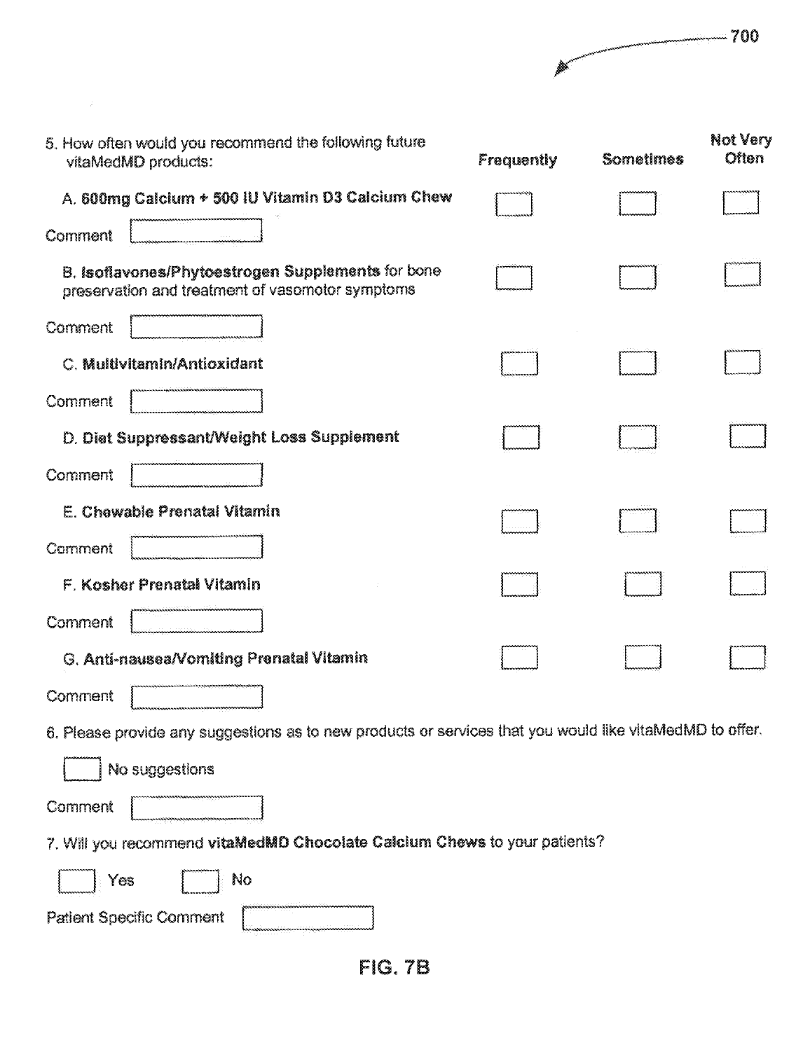

In various embodiments, FIGS. 6A, 6B, and 6C and FIGS. 7A and 7B provide examples of surveys that may be generated by the system and methods described herein. In FIG. 6A, 6B, and 6C an exemplary survey 700 is shown providing choices for weighted value responses to questions related to an item. In this example, the survey 700 is directed to the dealer, and a text field is provided for inclusion of the dealer's comments relative to the customer or the customer's comments, if the customer has provided any. In this example, the item is a prenatal vitamin and supplement; however, any other item may be the subject of the survey. Similarly, FIGS. 7A and 7B show an exemplary survey 700 for obtaining information for another item.

Systems, methods and computer program products are provided. In the detailed description herein, references to “various embodiments”, “one embodiment”, “an embodiment”, “an example embodiment”, etc indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the e relevant art(s) how to implement the disclosure in alternative embodiments.

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; customer data; dealer data; and/or like data useful in the operation of the system. As those skilled in the art will appreciate, user computer may include an operating system Windows NT, Windows 95/98/2000, Windows XP, Windows Vista, Windows 7, OS2, UNIX, Linux Solaris, MacOS, etc.) as well as various conventional support software and drivers typically associated with computers. A user may include any individual, business, entity, government organization, software and/or hardware that interact with a system.

A web client includes any device (e.g., personal computer) which communicates via any network, for example such as those discussed herein. Such browser applications comprise Internet browsing software installed within a computing unit or a system to conduct online transactions and/or communications. These computing units or systems may take the form of a computer or set of computers, although other types of computing units or systems may be used, including laptops, notebooks, tablets, hand held computers, personal digital assistants, set-top boxes, workstations, computer-servers, main frame computers, mini-computers, PC servers, pervasive computers, network sets of computers, personal computers, such as Wads, iMACs, and MacBooks, kiosks, terminals, point of sale (POS) devices and/or terminals, televisions, or any other device capable of receiving data over a network. A web-client may run Microsoft Internet Explorer, Mozilla Firefox, Google Chrome, Apple Safari, or any other of the myriad software packages available for browsing the internet.

Practitioners will appreciate that a web client may or may not be in direct contact with an application server. For example, a web client may access the services of an application server through another server and/or hardware component, which may have a direct or indirect connection to an Internet server. For example, a web client may communicate with an application server via a load balancer. In an exemplary embodiment, access is through a network or the Internet through a commercially-available web-browser software package.

As those skilled in the art will appreciate, a web client includes an operating system (e.g., Windows NT, 95/98/2000/CE/Mobile, OS2, UNIX, Linux, Solaris, MacOS, PalmOS, etc.) as well as various conventional support software and drivers typically associated with computers. A web client may include any suitable personal computer, network computer, workstation, personal digital assistant, cellular phone, smart phone, minicomputer, mainframe or the like. A web client can be in a home or business environment with access to a network. In an exemplary embodiment, access is through a network or the Internet through a commercially available web-browser software package. A web client may implement security protocols such as Secure Sockets Layer (SSL) and Transport Layer Security (TLS). A web client may implement several application layer protocols including http, https, ftp, and sftp.

In an embodiment, various components, modules, and/or engines of system 100 may be implemented as micro-applications or micro-apps. Micro-apps are typically deployed in the context of a mobile operating system, including for example, a Palm mobile operating system, a Windows mobile operating system, an Android Operating System, Apple iOS, a Blackberry operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., iPhone®, Palm Pilot®, Blackberry®), cellular phone, kiosk, etc.), online communications, satellite communications, off-fine communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, Dilip Naik, Internet Standards and Protocols (1990; Java 2 Complete, various authors, (Sybex 1999); Deborah Ray and Eric Ray, Mastering HTML 4.0 (1997); and Loshin, TCP/IP Clearly Explained (1997) and David Gourley and Brian Tatty, HTTP, The Definitive Guide (2002), the contents of which are hereby incorporated by reference.

The various system components may be independently, separately or collectively suitably coupled to the network via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e,g., Gilbert Held, Understanding Data Communications (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, sec the NIST's (National Institute of Standards and Technology) definition of cloud computing at http://csrc.nist.gov/groups/SNS/cloud-computing/cloud-def-v15.do.c (last visited Feb. 4, 2011), which is hereby incorporated by reference in its entirety.

As used herein, “transmit” may include sending electronic data from one system component to another over a network connection. Additionally, as used herein, “data” may include encompassing information such as commands, queries, files, data for storage, and the like in digital or any other form.

The system contemplates uses in association with web services, utility computing, pervasive and individualized computing, security and identity solutions, autonomic computing, cloud computing, commodity computing, mobility and wireless solutions, open source, biometrics, grid computing and/or mesh computing.

Any databases discussed herein may include relational, hierarchical, graphical, or object-oriented structure and/or any other database configurations. Common database products that may be used to implement the databases include DB2 by IBM (Armonk, N.Y.), various database products available from Oracle Corporation (Redwood Shores, Calif.), Microsoft Access or Microsoft SQL Server by Microsoft Corporation (Redmond, Wash.), MySQL by MySQL AB (Uppsala, Sweden), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key, field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In one exemplary embodiment, the ability to store a wide variety of information in different formats is facilitated by storing the information as a BLOB. Thus, any binary information can be stored in a storage space associated with a data set. The BLOB method may store data sets as ungrouped data elements formatted as a block of binary via a fixed memory offset using either fixed storage allocation, circular queue techniques, or best practices with respect to memory management (e.g., paged memory, least recently used, etc). By using BLOB methods, the ability to store various data sets that have different formats facilitates the storage of data for multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific, issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

Encryption may be performed by way of any of the techniques now available in the art or which may become available—e.g., Twofish, RSA, El Gamal, Schorr signature, DSA, POP, PKI, and symmetric and asymmetric cryptosystems.

The computing unit of the web client may be further equipped with an Internet browser connected to the Internet or an intranet using standard dial-up, cable, DSL or any other Internet protocol known in the art. Requests originating at a web client may pass through a firewall in order to prevent unauthorized access from users of other networks. Further, additional firewalls may be deployed between the varying components of CMS to further enhance security.

Firewall may include any hardware and/or software suitably configured to protect CMS components and/or enterprise computing resources from users of other networks. Further, a firewall may be configured to limit or restrict access to various systems and components behind the firewall for web clients connecting through a web server. Firewall may reside in varying configurations including Stateful inspection, Proxy based, access control lists, and Packet Filtering among others. Firewall may be integrated within an web server or any other CMS components or may further reside as a separate entity. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the Internet. A firewall may be integrated as software within an Internet server, any other application server components or may reside within another computing device or may take the form of a standalone hardware component.

The computers discussed herein may provide a suitable website or other Internet-based graphical user interface which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Interbase, etc., may be used to provide an Active Data Object (ADO) compliant database management system. In one embodiment, the Apache web server is used in conjunction with a Linux operating system, a MySQL database, and the Perl, PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), AJAX (Asynchronous Javascript And XML), helper applications, plug-ins, and the like. A server may include a web service that receives a request from a web server, the request including a URL (http://yahoo.com/stockquotes/ge) and an IP address (123,56,789.234). The web server retrieves the appropriate web pages and sends the data or applications for the web pages to the IP address. Web services are applications that are capable of interacting with other applications over a communications means, such as the Internet. Web services are typically based on standards or protocols such as XML, SOAP, AJAX, WSDL and UDDI. Web services methods are well known in the art, and are covered in many standard texts. See, e.g., ALEX NGHIEM IT WEB SERVICES: A ROADMAP FOR THE ENTERPRISE (2003), hereby incorporated by reference.

Middleware may include any hardware and/or software suitably configured to facilitate communications and/or process requests between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the Internet server. Middleware may be configured to process requests and/or instructions between the various components of an application server and any number of internal or external systems for any of the purposes disclosed herein. WebSphere MQTM (formerly MQSeries) by IBM, Inc. (Armonk, N.Y.) is an example of a commercially available middleware product. An Enterprise Service Bus (“ESB”) application is another example of middleware.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

Each participant is equipped with a computing device in order to interact with the system and facilitate online commerce transactions. The customer has a computing unit in the form of a personal computer, although other types of computing units may be used including laptops, notebooks, hand held computers, set-top boxes, cellular telephones, touch-tone telephones and the like. The merchant has a computing unit implemented in the form of a computer-server, although other implementations are contemplated by the system. The bank has a computing center shown as a main frame computer. However, the bank computing center may be implemented in other forms, such as a mini-computer, a PC server, a network of computers located in the same of different geographic locations, or the like. Moreover, the system contemplates the use, sale or distribution of any goods, services or information over any network having similar functionality described herein

As will be appreciated by one of ordinary skill in the art, the system may be embodied as a customization of an existing system, an add-on product, a processing apparatus executing upgraded software, a stand alone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also he stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” should he construed to exclude only those types of transitory computer-readable media which were found in In Re Nuijten to fall outside the scope of patentable subject matter under 35 U.S.C. § 101.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to he limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase he interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method, comprising:
receiving, by a computer based system for analyzing survey data, response data from a plurality of completed surveys related to an item;
parsing, by the computer based system, the response data into a plurality of subsets based on at least one of a survey type, a product identifier, and a user identifier;
analyzing, by the computer based system, at least one of the subsets; and
creating, by the computer based system, a representation of at least one of the plurality of subsets, wherein the representation is indicative of use of the item.

2. The method of claim 1, wherein the item is at least one of a product and a service.

3. The method of claim 1, wherein the product is at least one of a prescription medication, a prescription medical supplement, and a non-prescription supplement.

4. The method of claim 1, wherein the response data comprises objective response data, wherein the objective response data is a response to a survey question associated with predefined answers.

5. The method of claim 1, wherein the response data comprises subjective response data, wherein the subjective response data is response to a survey question that is not associated with predefined answers.

6. The method of claim 5, further comprising:
sorting, by the computer based system, the subjective data based on a key word; and
identifying, by the computer based system, the subjective data comprising the key word.

7. The method of claim 6, further comprising:
grouping, by the computer based system, the subjective data comprising the key word; and
creating, by the computer based system, a report, wherein the key word is modified in the report.

8. The method of claim 7, wherein the key word is an attribute of a product.

9. The method of claim 8, wherein the attribute of a product is a predefined key characteristic of the product, and wherein the subjective data describes an improvement to the product and comprises the key word.

10. The method of claim 1, further comprising:
validating, by the computer based system, a user based on login information; and
displaying, by the computer based system, a plurality of options in response to the login information matching criteria associated with a user.

11. The method of claim 10, wherein the plurality of options comprise at least one of a report option, a task list option, and a survey completion history option.

12. The method of claim 11, further comprising:
receiving, by the computer based system, a selection associated with the report option;
receiving, by the computer based system, an item selection in response to receiving the selection of the report option;
displaying, by the computer based system, an indicator of the user's use of the item and the total use of the item.

13. The method of claim 12, wherein the user is associated with a group of customers.

14. The method of claim 13, wherein the group of customers have received a recommendation for the item from at least one of the user and an affiliate of the user.

15. The method of claim 14, wherein the recommendation is associated with a re-occurring order for the item.

16. The method of claim 15, further comprising:
tracking, by the computer based system, an activity of a customer, wherein the activity is associated with the re-occurring order for the item;
displaying, by the computer based system, the status of the re-occurring order, wherein the status is associated with the customer.

17. The method of claim 11, further comprising:
receiving, by the computer based system, a selection associated with the task list;
displaying, by the computer based system, a task in response to receiving the selection of the report option, wherein the task is displayed based on an item associated with the user;
receiving, by the computer based system, first data and second data, wherein the first data is a selection of predefined answer associated with a first survey question, and wherein the second data is information provided by a user associated with an observation about the item from the user.

18. The method of claim 17, wherein the second data is provided in a field, and wherein the field is associated with a particular set of predetermined key characteristics that suggest how the observation from the user should be described.

19. A tangible non-transitory computer-readable storage medium having computer-executable instructions stored thereon that, if executed by a computer based system for analyzing survey data, causes the computer based system to perform operations comprising:
receiving, by the computer based system, response data from a plurality of completed surveys related to an item;
parsing, by the computer based system, the response data into a plurality of subsets based on at least one of a survey type, a product identifier, and a user identifier;
analyzing, by the computer based system, at least one of the subsets; and
creating, by the computer based system, a representation of at least one of the plurality of subsets, wherein the representation is indicative of use of the item.

20. A system for analyzing survey data comprising:
a network interface communicating with a memory;
the memory communicating with a processor for analyzing survey data; and
the processor, when executing a computer program, is configured to perform operations comprising:
receiving, by the processor, response data from a plurality of completed surveys related to an item;
parsing, by the processor, the response data into a plurality of subsets based on at least one of a survey type, a product identifier, and a user identifier;
analyzing, by the processor, at least one of the subsets; and
creating, by the processor, a representation of at least one of the plurality of subsets, wherein the representation is indicative of use of the item.
